(19) United States
(12) Patent Application Publication
(10) Pub. No.: US 2024/0265328 A1
(43) Pub. Date: Aug. 8, 2024

(54) SALES SUPPORT DEVICE, SALES SUPPORTING METHOD, AND STORAGE MEDIUM

(71) Applicant: NEC Corporation, Minato-ku, Tokyo (JP)

(72) Inventor: Yasuhiro Ajiro, Tokyo (JP)

(73) Assignee: NEC Corporation, Minato-ku, Tokyo (JP)

(21) Appl. No.: 18/567,134

(22) PCT Filed: Jun. 11, 2021
(86) PCT No.: PCT/JP2021/022262

§ 371 Date: Dec. 5, 2023

(51) Int. Cl. G06Q 10/0637; G06V 30/19

(52) U.S. Cl. CPC G06Q 10/06375; G06V 30/19093

(57) ABSTRACT

To more accurately identify a business negotiation similar to a target business negotiation, a sales support apparatus (10) includes: an obtaining section (11) that obtains a first document set including one or more first documents in each of which contents of a first business negotiation are described in a natural language; and an identification section (12) that refers, for each of multiple second business negotiations that are other than the first business negotiation, to a storage device storing a second document set including a second document in which contents of the second business negotiation are described in a natural language, and identifies a second business negotiation that is similar to the first business negotiation from among the second business negotiations, on the basis of a degree of similarity between the first document set and the second document set.

### TECHNICAL FIELD

The present invention relates to sales support apparatuses, sales supporting methods, and programs.

### BACKGROUND ART

A technique for predicting a result of a business negotiation has been proposed. Patent Literature 1 discloses a production plan preparation apparatus that creates a production plan in which a production amount allocation is optimized such that a profit is maximized in view of a probability of receiving an order of steel products. The order information database disclosed in Patent Literature 1 includes information on past orders (orders received) including information on orders not received, and information on orders expected to be received (on expected orders each having a prospect of winning an order). The production plan preparation apparatus refers to order information stored in the order information database and calculates the degree of similarity between the data as to each expected order of a production plan target and the orders received. Then, the probability of success in receiving an order on the expected order is calculated on the basis of the calculated degree of similarity.

### CITATION LIST

### Patent Literature

### [Patent Literature 1]

Japanese Patent Application Publication Tokukai No. 2014-109845

### SUMMARY OF INVENTION

### Technical Problem

Here, various factors associated with a business negotiation, such as how a sales representative specifically conducts a sales activity, affect whether or not a business negotiation succeeds. Since the degree of similarity between the information on an order expected to be received and the information on the past orders, with reference to the information on the past orders, in the technology disclosed in Patent Literature 1, it seems to be difficult to calculate the degree of similarity of business negotiations, taking into account such various factors associated with the business negotiation.

An example aspect of the present invention is accomplished in view of these problems, and an example object thereof is to provide a technique that more accurately identifies a business negotiation similar to a business negotiation of interest.

### Solution to Problem

A sales support apparatus in accordance with an example aspect of the present invention includes: obtaining means that obtains a first document set including one or more first documents in each of which contents of a first business negotiation are described in a natural language; and identification means that refers, for each of multiple second business negotiations that are other than the first business negotiation, to a storage device storing a second document set including a second document in which contents of the second business negotiation are described in a natural language, and identifies a second business negotiation that is similar to the first business negotiation from among the second business negotiations, on the basis of a degree of similarity between the first document set and the second document set.

A sales supporting method in accordance with an example aspect of the present invention includes: obtaining, by a sales support apparatus, a first document set including one or more first documents in each of which contents of a first business negotiation are described in a natural language; and by the sales support apparatus, referring, for each of multiple second business negotiations that are other than the first business negotiation, to a storage device that stores a second document set including a second document in which contents of the second business negotiation are described in a natural language, and identifying a second business negotiation that is similar to the first business negotiation from among the second business negotiations, on the basis of a degree of similarity between the first document set and the second document set.

A program in accordance with an example aspect of the present invention is a program for causing a computer to function as a sales support apparatus, a program for causing a computer to function as a sales support apparatus, the program causing the computer to function as: obtaining means that obtains a first document set including one or more first documents in each of which contents of a first business negotiation are described in a natural language; and identification means that refers, for each of multiple second business negotiations that are other than the first business negotiation, to a storage device storing a second document set including a second document in which contents of the second business negotiation are described in a natural language, and identifies a second business negotiation that is similar to the first business negotiation from among the second business negotiations, on the basis of a degree of similarity between the first document set and the second document set.

### Advantageous Effects of Invention

According to an example aspect of the present invention, a second business negotiation having been conducted in the past, which is similar to a first business negotiation currently being conducted or scheduled to be conducted in the future, can be more appropriately identified.

### BRIEF DESCRIPTION OF DRAWINGS

FIG. 1 is a block diagram illustrating the configuration of a sales support apparatus in accordance with a first example embodiment of the present invention.

FIG. 2 is a flowchart illustrating the flow of a sales supporting method in accordance with the first example embodiment of the present invention.

FIG. 3 is a block diagram illustrating the configuration of a business negotiation management system in accordance with a second example embodiment of the present invention.

FIG. 4 is a table showing a specific example of a business negotiation record database in accordance with the second example embodiment of the present invention.

FIG. 5 is a table showing a specific example of a contract track record database in accordance with the second example embodiment of the present invention.

FIG. 6 is a flowchart illustrating the flow of a sales supporting method in accordance with the second example embodiment of the present invention.

FIG. 7 is a diagram illustrating a specific example of a calculation process of a degree of similarity in accordance with the second example embodiment of the present invention.

FIG. 8 is a diagram illustrating a specific example of information outputted in the second example embodiment of the present invention.

FIG. 9 is a diagram for describing a specific example of a calculation process of a degree of similarity in accordance with a third example embodiment of the present invention.

FIG. 10 is a block diagram illustrating the configuration of a computer that functions as sales support apparatuses or user terminals in accordance with the first to third example embodiments of the present invention.

### EXAMPLE EMBODIMENTS

### First Example Embodiment

The following description will discuss in detail a first example embodiment of the present invention with reference to the drawings. The present example embodiment is a basic form of example embodiments described later.

### <Configuration of Sales Support Apparatus>

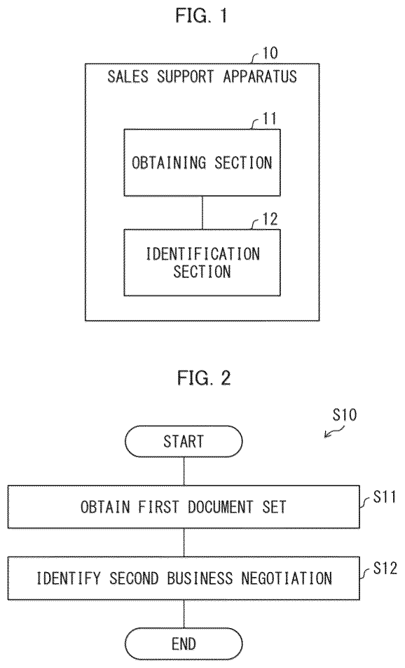

The following description will discuss the configuration of a sales support apparatus 10 in accordance with the present example embodiment with reference to FIG. 1. FIG. 1 is a block diagram illustrating the configuration of the sales support apparatus 10. The sales support apparatus 10 includes an obtaining section 11 and an identification section 12. The obtaining section 11 is an example configuration that realizes obtaining means recited in the claims. The identification section 12 is an example configuration that realizes identification means recited in the claims.

The obtaining section 11 obtains a first document set including one or more first documents in each of which the contents of a first business negotiation are described in a natural language. The identification section 12 refers, for each of multiple second business negotiations that are other than the first business negotiation, to a storage device storing a second document set including a second document in which the contents of the second business negotiation are described in a natural language, and the identification section 12 identifies a second business negotiation that has been conducted in the past and is similar to the first business negotiation currently being conducted or scheduled to be conducted in the future, from among the second business negotiations, on the basis of the degree of similarity between the first document set and the second document set. Note that examples of the document as used herein may include a sales daily report and a meeting record of a sales activity, and the document only needs to be one that includes the contents of a business negotiation.

Herein, the business negotiation refers to the exchange of various kinds of information as to a target matter between a person in charge belonging to a company, a business store, or the like, who provides a service or a product, and a customer. The business negotiation may be conducted face-to-face or may be conducted non-face-to-face via a network, a telephone, or the like. In a case of non-face-to-face, an interview may be conducted in real time (e.g., chat, on-line meeting) or may be conducted in non-real time (e.g., email, etc.). The number of persons in charge and the number of customers may each be one or more. The person in charge and the customer may be a robot, software, or the like.

The document includes the contents of the business negotiation described in a natural language. An example of the document may be a daily report created by a sales representative. Examples of the natural language may include Japanese, Chinese, and English. In the following description, for convenience of description, data indicative of a document is also simply referred to as a “document”. Examples of the document may include: text data indicating a character string indicative of the contents of a business negotiation; a file created by a predetermined word processing software; a file in PDF format, and a file in HTML format. The document may be, for example, data generated by a user operating an input device or the like, or alternatively, the document may be, for example, data generated by a device such as the sales support apparatus 10, executing a voice analysis process on a voice file indicative of the contents of a business negotiation.

### <Flow of Sales Supporting Method>

The following description will discuss a flow of a sales supporting method S10 in accordance with the present example embodiment with reference to FIG. 2. FIG. 2 is a flowchart illustrating the flow of the sales supporting method S10.

### (Step S11)

In step S11 (obtaining process), the obtaining section 11 obtains a first document set including one or more first documents in each of which the contents of a first business negotiation are described in a natural language. For example, the obtaining section 11 may obtain the one or more first documents from a device communicatively connected via a network, or alternatively, the obtaining section 11 may obtain the one or more first documents by loading them from a memory.

### (Step S12)

In step S12 (identification process), the identification section 12 refers, for each of multiple second business negotiations that are other than the first business negotiation, to a storage device storing a second document set including a second document in which the contents of the second business negotiation are described in a natural language, and the identification section 12 identifies a second business negotiation that is similar to the first business negotiation from among the second business negotiations, on the basis of the degree of similarity between the first document set and the second document set. The degree of similarity is information indicative of the degree of similarity between the first document set and the second document set.

For example, the identification section 12 calculates the degree of similarity between the first document set and the second document set on the basis of the degree of similarity between each first document included in the first document set and each second document included in the second document set. As a method of determining similarity between document sets, the identification section 12 may, for example, use a method of calculating a distance in a predetermined feature space between words included in documents. In this case, the identification section 12 calculates the degree of similarity between a first document and a second document on the basis of the distance between a word included in the first document and a word included in the second document. In this case, the degree of similarity between the first document and the second document decreases as the distance between the documents increases, and increases as the distance between the documents decreases. Further, the identification section 12 calculates the degree of similarity between the first document set and the second document set on the basis of the degree of similarity between each first document included in the first document set and each second document included in the second document set. Note that a process of calculating the degree of similarity between the first document set and the second document set is not limited to the one described in the foregoing.

As described in the foregoing, the sales support apparatus 10 in accordance with the present example embodiment employs a configuration in which the second business negotiation that is similar to the first business negotiation is identified on the basis of the degree of similarity between the first document set describing the contents of the first business negotiation and the second document set describing the contents of the second business negotiation. Determining the similarity between business negotiations on the basis of the similarity between documents in each of which the contents of the business negotiations are described in a natural language achieves an example advantage in that the sales support apparatus 10 in accordance with the present example embodiment can more accurately identify the second business negotiation that is similar to the first business negotiation.

### Second Example Embodiment

The following description will discuss in detail a second example embodiment of the present invention with reference to the drawings. Note that any constituent element that is identical in function to a constituent element described in the first example embodiment will be given the same reference numeral, and a description thereof will not be repeated.

### <Configuration of System>

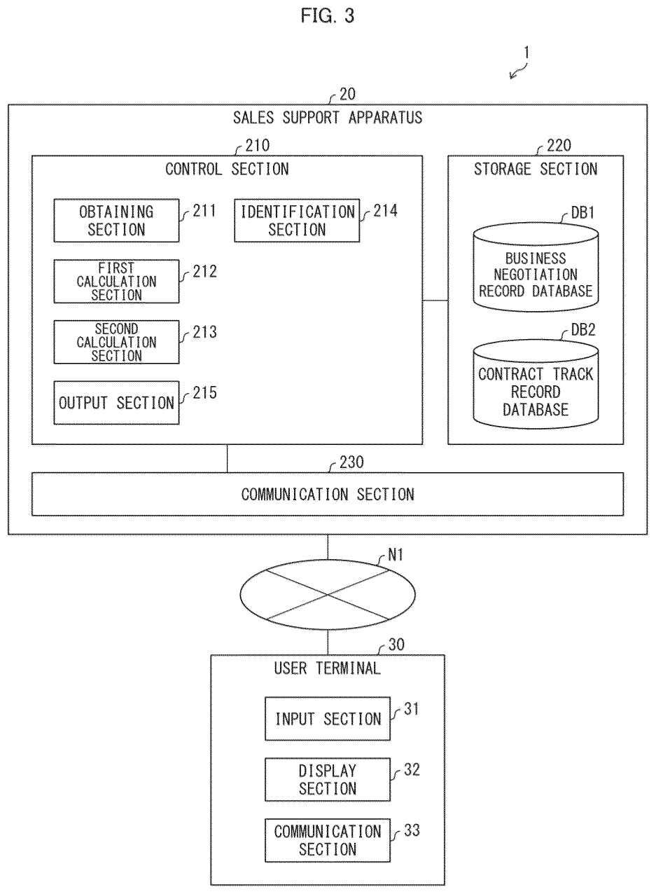

FIG. 3 is a block diagram illustrating the configuration of a business negotiation management system 1 in accordance with the present example embodiment. The business negotiation management system 1 is a system that manages business negotiations conducted by sales representatives and the like. The business negotiation management system includes a sales support apparatus 20 and a user terminal 30. The sales support apparatus 20 and the user terminal 30 are communicatively connected to each other via a network N1. Note that although FIG. 3 illustrates a single user terminal 30, the number of user terminals 30 to which the sales support apparatus 20 is connected is not limited thereto. Examples of the network N1 may include a wireless local area network (LAN), a wired LAN, a wide area network (WAN), a public network, a mobile data communication network, or a combination of these networks. Note that the configuration of the network N1 is not limited to these examples.

### <Configuration of Sales Support Apparatus>

The sales support apparatus 20 is an apparatus that outputs information obtained by predicting a result of a business negotiation. The sales support apparatus 20 includes a control section 210, a storage section 220, and a communication section 230. The control section 210 includes an obtaining section 211, a first calculation section 212, a second calculation section 213, an identification section 214, and an output section 215. The obtaining section 211 is an example configuration that realizes obtaining means recited in the claims. The first calculation section 212, the second calculation section 213, and the identification section 214 constitute an example configuration that realizes identification means recited in the claims. The output section 215 is an example configuration that realizes first output means and second output means recited in the claims.

In the present example embodiment, a result of a business negotiation indicates a success or failure in the business negotiation. However, a result of a business negotiation is not limited thereto. Such a result of a business negotiation may indicate, for example, a success, a success in part, a hold, a failure, or any of a variety of other results of the business negotiation. Hereinafter, the “information on a prediction of a result of business negotiation” may also be referred to as “information on a prediction of whether a business negotiation is likely to succeed”. Examples of a success in a business negotiation may include receiving an order for a product or service, or contracting a service or the like. Example of a failure in a business negotiation may include failure to receive an order for a product or service, or withdrawal from or cancellation of a service. Whether a business negotiation succeeds or not depends on specific contents of the business negotiation, such as sales contents of sales representatives. Examples of the contents of a business negotiation may include the contents of a material provided to a customer or the number of times interviews with a company officer are conducted.

The storage section 220 is an example configuration that realizes a storage device recited in the claims. The storage section 220 stores a business negotiation record database DB1 and a contract track record database DB2. The business negotiation record database DB1 stores business negotiation record data indicating the record of each of multiple business negotiations. Hereinafter, a “business negotiation the business negotiation record data of which is accumulated in the business negotiation record database DB1” may also be simply referred to as a “business negotiation accumulated in the business negotiation record database DB1”. Examples of the multiple business negotiations accumulated in the business negotiation record database DB1 may include a past business negotiation or a business negotiation currently in progress. The past business negotiation may be, for example, a business negotiation the result of which has been confirmed. In the present example embodiment, among the multiple business negotiations accumulated in the business negotiation record database DB1, a business negotiation currently in progress is adopted as a first business negotiation. When there is accumulated multiple business negotiations currently in progress in the business negotiation record database DB1, at least one of them is adopted as a first business negotiation. Further, among the multiple business negotiations accumulated in the business negotiation record database DB1, business negotiations other than the first business negotiation are adopted as second business negotiations. The business negotiation record data includes a document in which the contents of a business negotiation are described in a natural language. That is, the business negotiation record database DB1 stores a first document set (business negotiation record data of the first business negotiation) including one or more first documents in each of which the contents of the first business negotiation are described in a natural language. The business negotiation record database DB1 also stores, for each of the multiple second business negotiations, a second document set (business negotiation record data of the second business negotiations) including one or more second documents in each of which the contents of the second business negotiation are described in a natural language.

In the following description, in a case where it is not necessary to distinguish between a first business negotiation and a second business negotiation for convenience of description, these may also be simply referred to as a “business negotiation” or “business negotiations”. Further, in a case where it is not necessary to distinguish between a first document and a second document, these may also be simply referred to as a “document” or “documents”.

The contract track record database DB2 stores information indicative of the result of a business negotiation. The information indicative of the result of a business negotiation may be, for example, data indicative of success or failure in receiving an order.

The obtaining section 211 obtains a first document set including one or more first documents in each of which the contents of a first business negotiation are described in a natural language, by loading the first document set from the business negotiation record database DB1. Each first document included in the first document set includes information indicative of date and time. The information indicative of date and time indicates, for example, date and time at which the first document is created, or date and time at which a sales activity or the like described in the first document as the contents is performed. That is, the one or more first documents indicating the contents of the first business negotiation each has a rank order.

The first calculation section 212 refers to the business negotiation record database DB1 and calculates the degree of similarity between a first document included in the first document set and a second document included in the second document set. Details of a method of calculating the degree of similarity between a first document and a second document will be described later.

The second calculation section 213 calculates the degree of similarity between the first document set and the second document set, on the basis of the degree of similarity between the first document and the second document calculated by the first calculation section 212. The degree of similarity between the first document set and the second document set represents the degree of similarity between the first business negotiation and the second business negotiation.

The identification section 214 identifies a second business negotiation that is similar to the first business negotiation from among the second business negotiations, on the basis of the degree of similarity calculated by the second calculation section. For example, the identification section 214 identifies a second business negotiation that has the degree of similarity calculated by the second calculation section 213 and found to satisfy a predetermined condition. This predetermined condition may be, for example, such that the calculated degree of similarity is not less than a predetermined value (threshold).

The output section 215 outputs information on a prediction of whether the first business negotiation is likely to succeed. Specifically, the output section 215 outputs, for each of at least one or all of the second business negotiations, information indicative of the rank of the degree of similarity between the second document set associated with the second business negotiation and the first document set. The information indicative of the rank may be, for example, information indicative of a descending order or an ascending order of the degrees of similarity. That is, all of the second business negotiations accumulated in the business negotiation record database DB1 may be a target the rank of which is to be outputted, or alternatively, some of the second business negotiations may be the target. Further, the output section 215 refers to information indicative of the results of the second business negotiations registered in the contract track record database DB2 and outputs information obtained by predicting a result of the first business negotiation. The information indicative of the result may be, for example, information indicative of success or failure in the business negotiation, or information indicative of a probability of success or failure in the business negotiation (a numerical value or an icon).

The communication section 230 transmits and receives information to and from the user terminal 30 via the network N1, under the control of the control section 210. Hereinafter, a case where the control section 210 transmits and receives information to and from the user terminal 30 via the communication section 230 may simply be referred to as a case where the control section 210 transmits and receives information to and from the user terminal 30.

### <Configuration of User Terminal>

The user terminal 30 is a terminal that is used by a user. The user may be, for example, a sales representative who conducts a business negotiation. Examples of the user terminal 30 may include a laptop computer, a desktop computer, a tablet terminal, or a smartphone. The user terminal 30 includes an input section 31, a display section 32, and a communication section 33. The user terminal 30 is connected to an input device and a display device (both not illustrated). The input section 31 obtains, through the input device, a prediction request of a result of a first business negotiation. The input section 31 transmits the obtained prediction request to the sales support apparatus 20. The display section 32 outputs information on a prediction of the result of the first business negotiation outputted by the sales support apparatus 20.

The communication section 33 transmits and receives information to and from the sales support apparatus 20 via the network N1. Hereinafter, a case where the communication section 33 transmits and receives information to and from the sales support apparatus 20 may be simply referred to as a case where the user terminal 30 transmits and receives information to and from the sales support apparatus 20.

### (Specific Example of Business Negotiation Record Database)

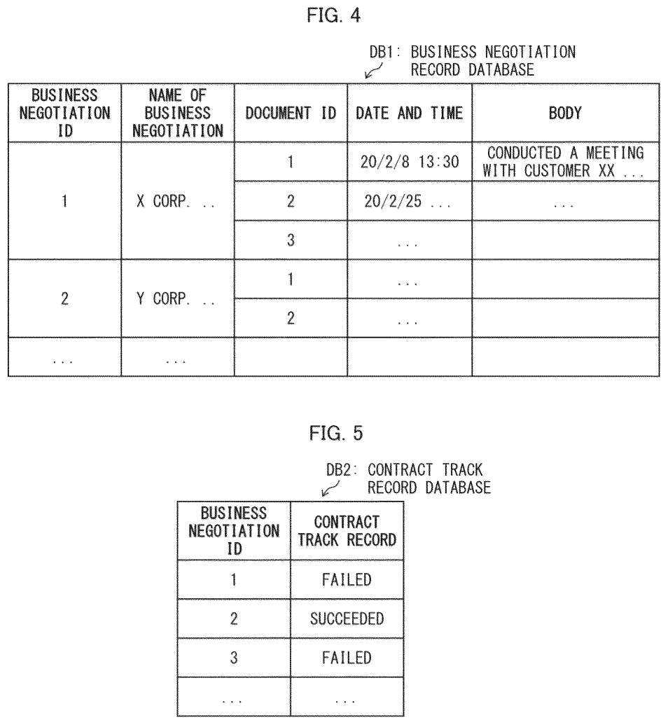

FIG. 4 is a table showing a specific example of the business negotiation record database DB1. In an example illustrated in FIG. 4, the business negotiation record database DB1 stores multiple types of business negotiation record data including items of “Business negotiation ID”, “Name of business negotiation”, “Document ID”, “Date and time of report”, and “Body”. Of these items, the item “Business negotiation ID” stores business negotiation IDs. The business negotiation ID is identification information for identifying a business negotiation. The item “Name of business negotiation” stores text information for identifying a business negotiation, such as a customer name and a project name, which are targets of the business negotiation.

The item “Document ID” stores document IDs. The document ID is identification information for identifying a document in which the contents of a business negotiation are described in a natural language. The item “Date and time of report” stores information indicative of date and time at which a report is made. The date and time at which the report is made may be, for example, a date and time at which a document indicating the contents of a business negotiation is registered in the business negotiation record database DB1.

The item “Body” stores data indicating the contents of a document. Examples of the document indicating the contents of a document may include: text data; a file created by a predetermined word processing software; a file in PDF format, and a file in HTML format. Note that the item “Body” may also store an address indicative of a storage destination of data indicating the contents of a document.

In the example of FIG. 4, multiple documents are associated with a single business negotiation. With each of the multiple documents, information indicative of date and time is associated. The information indicative of date and time indicates, for example, date and time at which the document is created, or date and time at which a sales activity or the like described in the document as the contents is performed. That is, the multiple documents describing the contents of the single business negotiation have a rank order.

### (Specific Example of Contract Track Record Database)

FIG. 5 is a table showing a specific example of the contract track record database DB2. In an example illustrated in FIG. 5, the contract track record database DB2 stores multiple types of contract track record data including items of “Business negotiation ID” and “Contract track record”. Of these items, the item “Business negotiation ID” stores business negotiation IDs for identifying business negotiations. The item “Contract track record” stores information indicative of the result of a business negotiation. The information indicative of the result of a business negotiation may be, for example, information indicative of success or failure in receiving an order.

### <Flow of Sales Supporting Method>

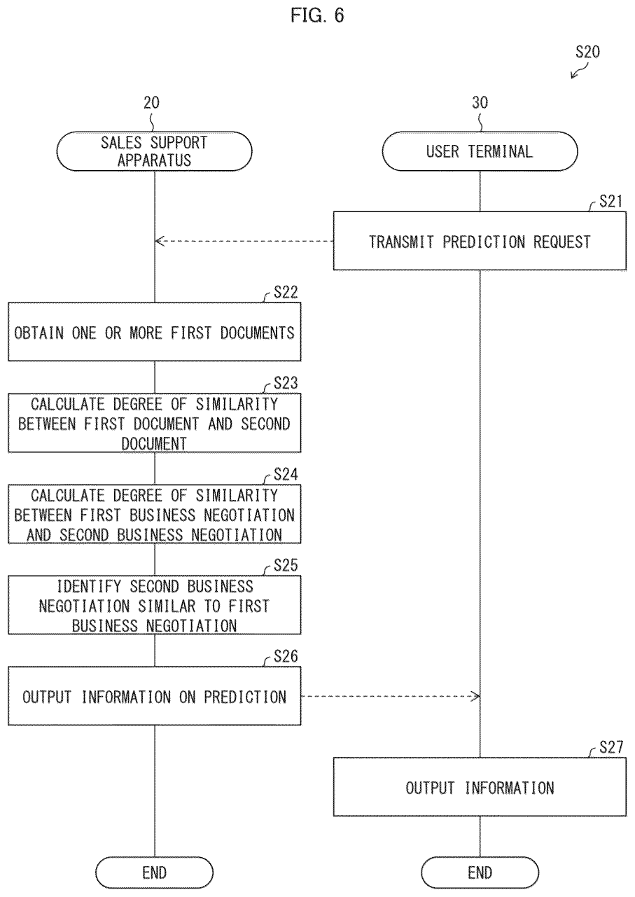

FIG. 6 is a flowchart illustrating the flow of a sales supporting method S20 carried out by the business negotiation management system 1. For example, the sales supporting method S20 is started, triggered by a user carrying out an operation for requesting prediction of a result of a first business negotiation with use of an input device. For example, the user may specify the first business negotiation by inputting the identification information for identifying the first business negotiation through the input device, or the user may carry out an operation of specifying the target first business negotiation from among the multiple business negotiations through an input device. In the present example embodiment, the first business negotiation is a business negotiation registered in the business negotiation record database DB1. Note that the first business negotiation may be a business negotiation that is not registered in the business negotiation record database DB1.

### (Step S21)

In step S21, the input section 31 of the user terminal 30 receives, through the input device, information indicative of a prediction request. The communication section 33 transmits the prediction request to the sales support apparatus 20 on the basis of the information received by the input section 31. The prediction request includes identification information for identifying the first business negotiation. The obtaining section 211 of the sales support apparatus 20 receives the prediction request from the user terminal 30.

### (Step S22)

In step S22, the obtaining section 211 of the sales support apparatus 20 obtains business negotiation record data (first document set) of the first business negotiation that is a target of the prediction request received. Specifically, the obtaining section 211 reads out, from the business negotiation record database DB1, one or more first documents included in the first document set.

### (Step S23)

In step S23, the first calculation section 212 calculates the degree of similarity between the one or more first documents included in the first document set obtained by the obtaining section 211, and one or more second documents included in the business negotiation record data (second document set) of each of the multiple second business negotiations accumulated in the business negotiation record database DB1.

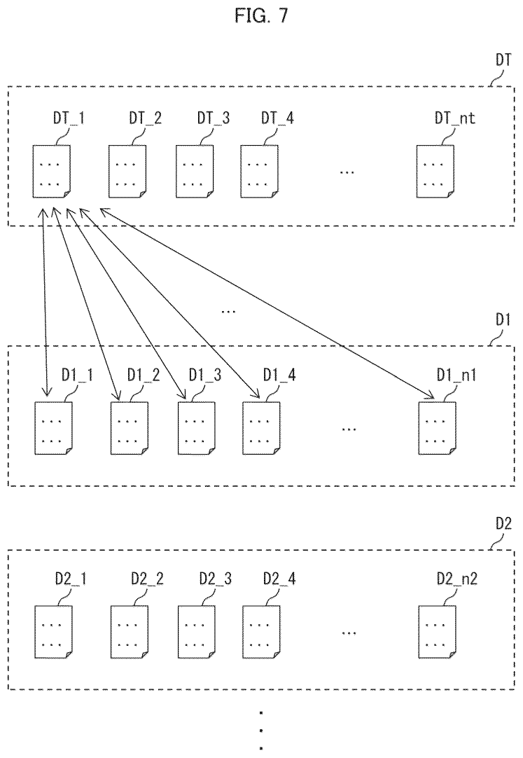

A specific example of the calculation process of the degree of similarity carried out by the first calculation section 212 will be described with reference to the drawings. FIG. 7 is a diagram illustrating the specific example of the calculation process of the degree of similarity carried out by the first calculation section 212. In the example illustrated in FIG. 7, the first calculation section 212 calculates the degree of similarity between each of the one or more first documents DT_i (1≤i≤nt; nt is a natural number of not less than 1) included in the first document set DT and each of the one or more second documents Dj_k (1≤k≤nj; nj is a natural number of not less than 1) included in the second document sets Dj (1<j≤N; N is a natural number of not less than 2).

In the example of FIG. 7, specifically, the first calculation section 212 calculates, for each of the first documents DT_1, DT_2, . . . , DT_nt included in the first document set DT, the degree of similarity to each of the second documents D1_1, D1_2, . . . , D1_n1 included in the second document set D1. Further, the first calculation section 212 calculates, for each of the first documents DT_1, DT_2, . . . , DT_nt included in the first document set DT, the degree of similarity to each of the second documents D2_1, D2_2, . . . , D2_n2 included in the second document set D2.

### (Method of Calculating Degree of Similarity Between First Document and Second Document)

The following will describe specific examples of a method in which the first calculation section 212 calculates the degree of similarity between the first document and the second document. The examples of the method may include: (a) a method based on inter-word distance; and (b) a method based on inter-document distance. Note that a method of determining similarity between the first document and the second document is not limited to these examples.

### (a: Method Based on Inter-Word Distance)

In a case where this method is employed, the first calculation section 212 calculates the degree of similarity between the first document and the second document on the basis of distances between words included in the documents. Specifically, the first calculation section 212 calculates an inter-word distance for each combination of a word included in the first document and a word included in the second document. For example, the first calculation section 212 may carry out natural language processing for each document included in the first and second document sets, and extracts words included in each document. For example, the natural language processing may be a morphological analysis or an N-gram analysis.

For example, the first calculation section 212 calculates an inter-word distance for each combination of a word w1i (i=1, 2, . . . , n) included in the first document and a word w2j (j=1, 2, . . . , m) included in the second document. Herein, n and m are natural numbers. In this case, there are n×m combinations of the word w1i and the word w2j. That is, the first calculation section 212 calculates n×m inter-word distances. In a case where a feature of each word w1i and a feature of each word w2j are expressed in the form of vectors, an inter-word distance can be represented by an angle between the two vectors or by a Euclidean distance between the vectors. As a technique for expressing a feature of a word in the form of a vector, it is possible to use a trained model which has been trained by machine learning so as to output a feature vector upon receiving input of a word. A technique such as word2vec can be employed as such a trained model, although the present invention is not limited thereto.

The first calculation section 212 calculates the degree of similarity between the first document and the second document, with use of a statistical value of inter-word distance. For example, the first calculation section 212 calculates an average value of inter-word distances of all combinations of the words w1i and the words w2j as the degree of similarity indicative of the degree of similarity between the first document and the second document. In this case, the degree of similarity indicates that the greater the value of the degree of similarity is, the lower the degree of similarity is, and conversely, the smaller the value is, the higher the degree of similarity is. Further, for example, the first calculation section 212 may select a predetermined number of combinations from among all combinations of the words w1i and the words w2j in ascending order of inter-word distances, and may then use, as the degree of similarity between the first document and the second document, an average value of inter-word distances for the selected combinations. Also in this case, the degree of similarity indicates that the greater the value of the degree of similarity is, the lower the degree of similarity is, and conversely, the smaller the value is, the higher the degree of similarity is.

### (b: Method Based on Inter-Document Distance)

In a case where this method is employed, the first calculation section 212 calculates the degree of similarity between the first document and the second document on the basis of distances between the documents. In a case where a feature of each document is expressed in the form of a vector, an inter-document distance between the first document and the second document can be represented by an angle between the two vectors or by a Euclidean distance between the vectors. As a technique for representing a feature of a document in the form of a vector, it is possible to use a trained model that has been trained by machine learning so as to output a feature vector upon receiving input of a document. A technique such as doc2vec can be employed as such a trained model, although the present invention is not limited thereto.

The first calculation section 212 may calculate the degree of similarity between the first document and the second document on the basis of the distance between the first document and the second document, and the first calculation section 212 may use the distance between the first document and the second document as the degree of similarity between the first document and the second document. In a case where the distance between the first document and the second document is used as the degree of similarity, the degree of similarity indicates that the greater the value is, the lower the degree of similarity is, and conversely, the smaller the value is, the higher the degree of similarity is.

### (Step S24)

In step S24 of FIG. 6, the second calculation section 213 calculates the degree of similarity between the first document set and each of the multiple second document sets, on the basis of the degree of similarity calculated by the first calculation section 212.

In the example illustrated in FIG. 7, the first calculation section 212 identifies one having the highest degree of similarity to the first document DT_1 from among the second documents D1_1, D1_2, . . . , and D1_n1 included in the second document set D1. The second calculation section 213 uses the degree of similarity of the identified second document as the degree of similarity d1_1 between the first document DT_1 and the second document set D1. Similarly, the first calculation section 212 identifies, from among the second documents D2_1, D2_2, . . . , and D2_n2 included in the second document set D2, a second document that has the highest degree of similarity to the first document DT_2. The first calculation section 212 uses the degree of similarity of the identified second document as the degree of similarity d1_2 between the first document DT_2 and the second document set D2. As such, the first calculation section 212 calculates the degree of similarity di_j between document DT_i (1≤i≤nt) and second document set Dj (1<j≤N).

The second calculation section 213 calculates the degree of similarity between the first document set DT and the second document set Dj on the basis of the degree of similarity di_j. For example, the second calculation section 213 sets the total value Σ(di_1) of the degrees of similarity di_1 or the average value {Σ(di_1)}/nt of the degrees of similarity di_1, as the degree of similarity between the first document set DT and the second document set D1. As such, the second calculation section 213 calculates the degree of similarity dj between the first document set DT and the second document set Dj by using, for example, the following equation (1) or equation (2). Note that a method of calculating the degree of similarity between the first document set DT and the second document set Dj is not limited to these methods, and the second calculation section 213 may calculate the degree of similarity by other methods.

$$dj = {\sum }_{i} di \_ j \qquad ( 1 )$$

$$dj = ( {\sum }_{i} di \_ j ) / nt \qquad ( 2 )$$

### (Step S25)

In step S25 of FIG. 6, the identification section 214 identifies one or more second business negotiations that are similar to the first business negotiation, on the basis of the degrees of similarity calculated by the second calculation section 213 in step S24. For example, the identification section 214 identifies, from among the multiple second business negotiations, second business negotiations of the top M cases (M is an integer of 2 or more) in ascending order of degrees of similarity. Further, for example, the identification section 214 may determine whether or not the multiple second business negotiations are similar to the first business negotiation by using a predetermined threshold.

### (Step S26)

In step S26, the output section 215 generates information on a prediction of a result of the first business negotiation, and outputs the generated information to the user terminal 30. Here, the information is generated on the basis of the degree of similarity calculated by the second calculation section 213 and/or the one or more second business negotiations identified by the identification section 214. For example, the output section 215 outputs, for each of at least one or all of the multiple second business negotiations stored in the business negotiation record database DB1, information indicative of the rank of the degree of similarity between a second document set associated with the second business negotiation and the first document set. Further, for example, the output section 215 refers to information indicative of the result of the second business negotiation identified by the identification section 214, and outputs information obtained by predicting a result of the first business negotiation.

For example, the information outputted by the output section 215 is data indicative of: an image indicating the result of sorting the multiple second business negotiations by degrees of similarity; an image in which colors, shapes, etc. of information indicative of a second business negotiation are made different depending on degree of similarity; or an image including a figure (such as a graph) indicative of the degree of similarity of each of the multiple second business negotiations.

Further, for example, the information outputted by the output section 215 may be an accuracy of success in the first business negotiation or an accuracy of failure in the first business negotiation. That is, for example, the output section 215 refers to information indicative of the result of the second business negotiation identified by the identification section 214, and outputs an accuracy of success in the first business negotiation or an accuracy of failure in the first business negotiation.

For example, the output section 215 calculates an accuracy R/N of success in the first business negotiation by using (i) the number M of one or more second business negotiations identified by the identification section 214 and (ii) the number R of successful business negotiation or negotiations among the M second business negotiation or negotiations. Further, for example, the output section 215 calculates an accuracy L/N of failure in the first business negotiation by using (i) the number M of one or more second business negotiations identified by the identification section 214 and (ii) the number L of failed business negotiation or negotiations among the M second business negotiation or negotiations.

### (Step S27)

The user terminal 30 receives information from the sales support apparatus 20. In step S27, the user terminal 30 outputs information received from the sales support apparatus 20. For example, the user terminal 30 displays, on the display device, an image indicating image data received from the sales support apparatus 20.

### <Example Image>

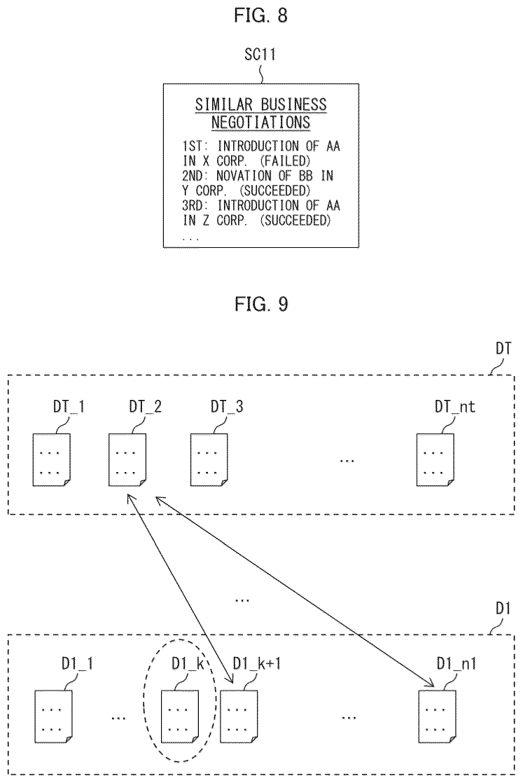

FIG. 8 is a diagram illustrating a specific example of the information outputted by the user terminal 30 in step S26. An example image SC11 in FIG. 8 shows multiple second business negotiations shown in ascending order of degrees of similarity to the first business negotiation. Further, the example image SC11 shows the results of the multiple second business negotiations (e.g., success/failure in receiving an order).

Since the example image SC11 shows the results (e.g., success/failure in receiving an order) of the second business negotiations similar to the first business negotiation, the user can easily predict whether the first business negotiation will be successful. Further, since the example image SC11 shows the second business negotiations in a sorted fashion and in rank order according to the degree of similarity, the user can more appropriately ascertain the second business negotiations used as a reference.

### Example Advantages of Present Example Embodiment

As described in the foregoing, the present example embodiment employs a configuration in which the sales support apparatus 20 outputs the information indicative of the ranks of degrees of similarity between the second document set and the first document set. Thus, the sales support apparatus 20 in accordance with the present example embodiment allows a user or the like to easily ascertain the second business negotiations similar to the first business negotiation.

Further, the present example embodiment employs a configuration in which the sales support apparatus 20 outputs the information obtained by predicting a result of the first business negotiation on the basis of the information indicative of the results of the second business negotiations similar to the first business negotiation. As such, the sales support apparatus 20 in accordance with the present example embodiment can more accurately predict the result of the first business negotiation.

Further, the present example embodiment employs a configuration in which the sales support apparatus 20 outputs the accuracy of success in the first business negotiation on the basis of the information indicative of the results of the second business negotiations similar to the first business negotiation. As such, the sales support apparatus 20 in accordance with the present example embodiment can more accurately predict the result of the first business negotiation.

Further, in accordance with the present example embodiment, the sales support apparatus 20 calculates the degree of similarity between a first case and a second case on the basis of the degree of similarity between the first document and the second document. This allows the sales support apparatus 20 to more appropriately calculate the degree of similarity between the first case and the second case.

### Variations

In the present example embodiment, when the accuracy of success in the first business negotiation is not more than a predetermined threshold, the output section 215 may output information indicating that the accuracy is not more than the predetermined threshold. For example, the output section 215 may show, in an image showing a list of first business negotiations, a first business negotiation that has the probability of failure in receiving order of not less than a threshold in a display mode different from that of the other first business negotiations. Since the output section 215 outputs the information indicating that the accuracy of success in a business negotiation is not more than a predetermined threshold, a user or the like can easily ascertain that the accuracy of success in a business negotiation is low.

Further, in the present example embodiment, the obtaining section 211 may obtain a first document set stored in a storage device other than the business negotiation record database DB1, instead of loading the first document set from the business negotiation record database DB1. For example, such a storage device may be communicatively connected to the sales support apparatus 20 via a network, or alternatively, a portable storage medium readable by the sales support apparatus 20. Further, instead of loading the first document set from the business negotiation record database DB1, the obtaining section 211 may obtain, as a first document set, text information or the like inputted through the input device. In this case, the prediction request inputted from the user terminal 30 in step S21 includes one or more first documents in each of which the contents of the first business negotiation are described in a natural language. Further, in step S22, the obtaining section 211 may obtain, for example, one or more first documents included in the received prediction request.

### Third Example Embodiment

The following description will discuss in detail a third example embodiment of the present invention with reference to the drawings. Note that any constituent element that is identical in function to a constituent element described in the first example embodiment or the second example embodiment will be given the same reference numeral, and a description thereof will not be repeated.

In the present example embodiment, a first document set includes multiple first documents stored on a time-series basis. The second document set includes multiple second documents stored on a time-series basis. The second calculation section 213 refers, among the second documents included in the second document set, to a second document that is similar to any one of the first documents included in the first document set and one or more second documents that are newer than the similar second document, and calculates the degree of similarity between the first document set and the set of the one or more newer second documents.

The first documents and the second documents in accordance with the present example embodiment are arranged in time series in accordance with, for example, information indicative of date and time. Note that the rank order of the first documents and the rank order of the second documents are not limited to those determined based on the information indicative of date and time. The rank order of the first documents and the rank order of the second documents may be, for example, those determined based on a file name, or alternatively, may be, for example, those determined based on a storage address of the file.

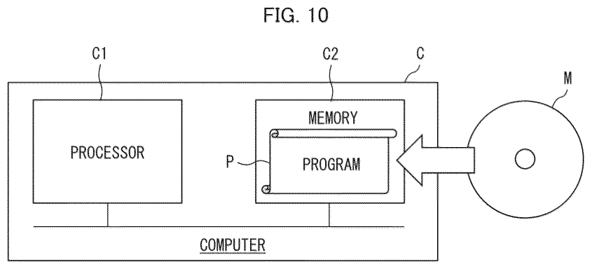

FIG. 9 is a diagram illustrating a specific example of a calculation process of the degree of similarity carried out by the first calculation section 212 and the second calculation section 213 in accordance with the present example embodiment. In the example of FIG. 9, the first calculation section 212 first calculates the degree of similarity between the first document DT_1 included in the first document set DT and each of the second documents D1_1, D1_2, . . . , D1_n1 included in the second document set D1, and identifies one having the highest degree of similarity. Herein, from among the second document set D1, the second document having the highest degree of similarity to the first document DT_1 is identified as a second document D1_k. The first calculation section 212 uses the degree of similarity of the identified second document D1_k as the degree of similarity d1_1 between the first document DT_1 and the second document set D1.

Then, the first calculation section 212 calculates the degree of similarity between each of second documents D1_k+1, D1_k+2, . . . , D1_n1, which ranks below the second document D1_k in the second document set D1, and the first document DT_2, and then, the first calculation section 212 identifies one having the highest degree of similarity. In the following description, a second document that has the highest degree of similarity to the first document DT_2 among the second documents D1_k+1, D1_k+2, . . . , D1_n1 is identified as a second document D1_k2. The first calculation section 212 uses the degree of similarity of the identified second document D1_k2 as the degree of similarity d2_1 between the first document DT_2 and the second document set D1.

Then, the first calculation section 212 calculates the degree of similarity between each of second documents D1_k2+1, D1_k2+2, . . . , D1_n1, which ranks below the second document D1_k2 in the second document set D1, and first document DT_3, and then, the first calculation section 212 identifies one having the highest degree of similarity. In the following description, a second document that has the highest degree of similarity to the first document DT_3 among the second documents D1_k2+1, D1_k2+2, . . . , D1_n1 is identified as a second document D1_k3. The first calculation section 212 uses the degree of similarity of the identified second document D1_k3 as the degree of similarity d3_1 between the first document DT_3 and the second document set D1.

As such, the first calculation section 212 determines, as the degree of similarity di_j between the first document DT_i and the second document set Dj, the degree of similarity of the second document having the highest degree of similarity to the first document DT_i among the second documents that rank below the second document Dj_k(i−1). Here, the second document Dj_k(i−1) is a document that is determined, by the first calculation section 212, to have the highest degree of similarity to the first document DT_(i−1) in the second document set Dj.

The second calculation section 213 calculates the degree of similarity dj between the first document set DT and the second document set Dj on the basis of the degree of similarity di_j. For example, the second calculation section 213 calculates the degree of similarity dj between the first document set DT and the second document set Dj by using the abovementioned equation (1) or (2) described in the second example embodiment.

According to the present example embodiment, the sales support apparatus 20 refers, among the second documents included in the second document set, to a second document that is similar to any one of the first documents included in the first document set and one or more second documents that are newer than the similar second document, and calculates a degree of similarity between the first document set and the set of the one or more newer second documents. This allows the sales support apparatus 20 to more appropriately calculate the degree of similarity between the first document set and the second document set.

### Fourth Example Embodiment

The following description will discuss in detail a fourth example embodiment of the present invention with reference to the drawings. Note that any constituent element that is identical in function to a constituent element described in any one(s) of the first to third example embodiments will be given the same reference numeral, and a description thereof will not be repeated.

In the present example embodiment, the second calculation section 213 calculates, as the degree of similarity between the first document set and the second document set, the degree of similarity between a first document having a predetermined attribute among the first document set, and a second document having the attribute among the second document set.

For example, the attribute may indicate the type of industry of the corporate customer, the size of the corporate customer, the price range of the commercial material, the job title of the participant from the customer, the reaction of the customer, or the measure on one's own. For example, the second calculation section 213 calculates, as the degree of similarity between the first document set and the second document set, the degree of similarity between (i) one or more first documents having an attribute indicative of the customer response “Good”, among the first document set, and (ii) one or more second documents having an attribute indicative of the customer response “Good”, among the second document set. As a method of calculating the degree of similarity between a first document and a second document, used is a method described above in the second example embodiment.

According to the present example embodiment, the sales support apparatus 20 calculates, as the degree of similarity between the first document set and the second document set, the degree of similarity between a first document having a predetermined attribute and a second document having the predetermined attribute. This allows the sales support apparatus 20 to more appropriately calculate the degree of similarity between the first document set and the second document set.

### Software Implementation Example

Some or all of the functions of the sales support apparatuses 10, 20 and the user terminal 30 (hereinafter, referred to as the “sales support apparatus 10 etc.”) can be realized by hardware such as an integrated circuit (IC chip) or can be alternatively realized by software.

In the latter case, the sales support apparatus 10 etc. are realized by, for example, a computer that executes instructions of a program that is software realizing the foregoing functions. FIG. 10 illustrates an example of such a computer (hereinafter, referred to as “computer C”). The computer C includes at least one processor C1 and at least one memory C2. The memory C2 stores a program P for causing the computer C to function as the sales support apparatus 10 etc. In the computer C, the processor C1 reads the program P from the memory C2 and executes the program P, so that the functions of the sales support apparatus 10 etc. are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. As the memory C2, for example, it is possible to use a flash memory, a hard disk drive (HDD), a solid state drive (SSD), or a combination of these.

Note that the computer C can further include a random access memory (RAM) in which the program P is loaded when the program P is executed and in which various kinds of data are temporarily stored. The computer C may further include a communication interface for transmitting and receiving data to and from other devices. The computer C may further include an input-output interface for connecting input-output devices such as a keyboard, a mouse, a display, and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium may be, for example, a communications network, a broadcast wave, or the like. The computer C can obtain the program P also via such a transmission medium.

### Additional Remark 1

The present invention is not limited to the above example embodiments, but can be altered in various ways by a person skilled in the art within the scope of the claims. For example, the present invention also encompasses, in its technical scope, any example embodiment derived by appropriately combining technical means disclosed in the foregoing example embodiments.

### Additional Remark 2

Some or all of the above example embodiments can be described as below. Note however that the present invention is not limited to example aspects described below.

### Supplementary Note 1

A sales support apparatus including:
obtaining means that obtains a first document set including one or more first documents in each of which contents of a first business negotiation are described in a natural language; and
identification means that refers, for each of multiple second business negotiations that are other than the first business negotiation, to a storage device storing a second document set including a second document in which contents of the second business negotiation are described in a natural language, and identifies a second business negotiation that is similar to the first business negotiation from among the second business negotiations, on the basis of a degree of similarity between the first document set and the second document set.

With this configuration, the sales support apparatus identifies the second business negotiation that is similar to the first business negotiation on the basis of the degree of similarity between the first document set describing the contents of the first business negotiation and the second document set describing the contents of the second business negotiation. This allows the sales support apparatus to more appropriately identify the second business negotiation that is similar to the first business negotiation.

### Supplementary Note 2

The sales support apparatus according to Supplementary note 1, further including first output means that outputs, for each of at least one or all of the second business negotiations, information indicative of a rank of a degree of similarity between the second document set associated with the second business negotiation and the first document set.

With this configuration, the sales support apparatus outputs the information indicative of the rank of the degree of similarity with respect to the first document set. This allows the sales support apparatus to facilitate a user or the like to ascertain the second business negotiation that is similar to the first business negotiation.

### Supplementary Note 3

The sales support apparatus according to Supplementary note 1 or 2, further including second output means that refers to information indicative of a result of the second business negotiation identified by the identification means, and outputs information obtained by predicting a result of the first business negotiation.

With this configuration, the sales support apparatus outputs the information predicting a result of the first business negotiation on the basis of the information indicative of the result of the second business negotiation similar to the first business negotiation. This allows the sales support apparatus to more accurately predict a result of the first business negotiation.

### Supplementary Note 4

The sales support apparatus according to Supplementary note 3, wherein the second output means refers to the information indicative of the result of the second business negotiation identified by the identification means, and outputs an accuracy of success in the first business negotiation.

With this configuration, the sales support apparatus outputs the accuracy of success in the first business negotiation on the basis of the result of the second business negotiation similar to the first business negotiation. This allows the sales support apparatus to more accurately predict a result of the first business negotiation.

### Supplementary Note 5

The sales support apparatus according to any one of Supplementary notes 1 to 4, wherein the identification means calculates the degree of similarity between the first document set and the second document set, on the basis of a degree of similarity between each first document included in the first document set and each second document included in the second document set.

With this configuration, the sales support apparatus calculates the degree of similarity between the first case and the second case on the basis of the degree of similarity between the first document and the second document. This allows the sales support apparatus to more appropriately calculate the degree of similarity between the first case and the second case.

### Supplementary Note 6

The sales support apparatus according to any one of Supplementary notes 1 to 5, wherein
the first document set includes multiple first documents stored on a time-series basis,
the second document set includes multiple second documents stored on a time-series basis, and
the identification means refers, among the second documents included in the second document set, to a second document that is similar to any one of the first documents included in the first document set and one or more second documents that are newer than the similar second document, and calculates a degree of similarity between the first document set and a set of the one or more newer second documents.

With this configuration, the sales support apparatus refers, among the second documents included in the second document set, to the second document that is similar to any one of the first documents included in the first document set and one or more second documents that are newer than the similar second document. This allows the sales support apparatus to more appropriately calculate the degree of similarity between the first document set and the set of the newer second documents.

### Supplementary Note 7

The sales support apparatus according to any one of Supplementary notes 1 to 6, wherein the identification means calculates, as the degree of similarity between the first document set and the second document set, a degree of similarity between a first document having a predetermined attribute among the first document set and a second document having the attribute among the second document set.

With this configuration, the sales support apparatus calculates the degree of similarity between the first document and the second document having the predetermined attribute as the degree of similarity between the first document set and the second document set. This allows the sales support apparatus to more appropriately calculate the degree of similarity between the first document set and the second document set.

### Supplementary Note 8

The sales support apparatus according to Supplementary note 4, wherein, when the accuracy is not more than a predetermined threshold, the second output means outputs information indicating that the accuracy is not more than the predetermined threshold.

With this configuration, the sales support apparatus outputs the information indicating that the accuracy of success is not more than the threshold, so that a user or the like can easily ascertain that the accuracy of success in a business negotiation is low.

### Supplementary Note 9

A sales supporting method including:
obtaining, by a sales support apparatus, a first document set including one or more first documents in each of which contents of a first business negotiation are described in a natural language; and
by the sales support apparatus, referring, for each of multiple second business negotiations that are other than the first business negotiation, to a storage device that stores a second document set including a second document in which contents of the second business negotiation are described in a natural language, and identifying a second business negotiation that is similar to the first business negotiation from among the second business negotiations, on the basis of a degree of similarity between the first document set and the second document set.

### Supplementary Note 10

A program for causing a computer to function as a sales support apparatus, the program causing the computer to function as:
obtaining means that obtains a first document set including one or more first documents in each of which contents of a first business negotiation are described in a natural language; and
identification means that refers, for each of multiple second business negotiations that are other than the first business negotiation, to a storage device storing a second document set including a second document in which contents of the second business negotiation are described in a natural language, and identifies a second business negotiation that is similar to the first business negotiation from among the second business negotiations, on the basis of a degree of similarity between the first document set and the second document set.

### Additional Remark 3

Some or all of the above example embodiments can also be described as below.

A sales support apparatus including at least one processor, the processor carrying out:
an obtaining process that obtains a first document set including one or more first documents in each of which contents of a first business negotiation are described in a natural language; and
an identification process that refers, for each of multiple second business negotiations that are other than the first business negotiation, to a storage device storing a second document set including a second document in which contents of the second business negotiation are described in a natural language, and identifies a second business negotiation that is similar to the first business negotiation from among the second business negotiations, on the basis of a degree of similarity between the first document set and the second document set.

Note that the sales support apparatus may further include a memory, which may store therein a program for causing the at least one processor to carry out the obtaining process and the identification process. The program may be stored in a computer-readable, non-transitory, tangible storage medium.

### REFERENCE SIGNS LIST

1 Business negotiation management system
10, 20 Sales support apparatus
11, 211 Obtaining section
12, 214 Identification section
30 User terminal
31 Input section
32 Display section
33, 230 Communication section
210 Control section
212 First calculation section
213 Second calculation section
215 Output section
220 Storage section
S10, S20 Sales supporting method

What is claimed is:

1. A sales support apparatus comprising at least one processor, the at least one processor carrying out:
an obtaining process that obtains a first document set including one or more first documents in each of which contents of a first business negotiation are described in a natural language; and
an identification process that refers, for each of multiple second business negotiations that are other than the first business negotiation, to a storage device storing a second document set including a second document in which contents of the second business negotiation are described in a natural language, and identifies a second business negotiation that is similar to the first business negotiation from among the second business negotiations, on the basis of a degree of similarity between the first document set and the second document set.

2. The sales support apparatus according to claim 1, the at least one processor further carrying out a first output process that outputs, for each of at least one or all of the second business negotiations, information indicative of a rank of a degree of similarity between the second document set associated with the second business negotiation and the first document set.

3. The sales support apparatus according to claim 1, the at least one processor further carrying out a second output means-process that refers to information indicative of a result of the second business negotiation identified in the identification process, and outputs information obtained by predicting a result of the first business negotiation.

4. The sales support apparatus according to claim 3, wherein, in the second output process, the at least one processor refers to the information indicative of the result of the second business negotiation identified in the identification, process, and outputs an accuracy of success in the first business negotiation.

5. The sales support apparatus according to claim 1, wherein, in the identification process, the at least one processor calculates the degree of similarity between the first document set and the second document set, on the basis of a degree of similarity between each first document included in the first document set and each second document included in the second document set.

6. The sales support apparatus according to claim 1, wherein
the first document set includes multiple first documents stored on a time-series basis,
the second document set includes multiple second documents stored on a time-series basis, and
in the identification process, the at least one processor refers, among the second documents included in the second document set, to a second document that is similar to any one of the first documents included in the first document set and one or more second documents that are newer than the similar second document, and calculates a degree of similarity between the first document set and a set of the one or more newer second documents.

7. The sales support apparatus according to claim 1, wherein, in the identification process, the at least one processor calculates, as the degree of similarity between the first document set and the second document set, a degree of similarity between a first document having a predetermined attribute among the first document set and a second document having the attribute among the second document set.

8. The sales support apparatus according to claim 4, wherein, when the accuracy is not more than a predetermined threshold, in the second output process, the at least one processor outputs information indicating that the accuracy is not more than the predetermined threshold.

9. A sales supporting method comprising:
obtaining, by a sales support apparatus, a first document set including one or more first documents in each of which contents of a first business negotiation are described in a natural language; and
by the sales support apparatus, referring, for each of multiple second business negotiations that are other than the first business negotiation, to a storage device that stores a second document set including a second document in which contents of the second business negotiation are described in a natural language, and identifying a second business negotiation that is similar to the first business negotiation from among the second business negotiations, on the basis of a degree of similarity between the first document set and the second document set.

10. A non-transitory storage medium storing a program for causing a computer to function as a sales support apparatus, the program causing the computer to carry out:
an obtaining process that obtains a first document set including one or more first documents in each of which contents of a first business negotiation are described in a natural language; and
an identification process that refers, for each of multiple second business negotiations that are other than the first business negotiation, to a storage device storing a second document set including a second document in which contents of the second business negotiation are described in a natural language, and identifies a second business negotiation that is similar to the first business negotiation from among the second business negotiations, on the basis of a degree of similarity between the first document set and the second document set.
